(19) United States
(12) Patent Application Publication
(10) Pub. No.: US 2005/0236874 A1
(43) Pub. Date: Oct. 27, 2005

(54) Automobile pet bed construction

(75) Inventors: Donald E. Godshaw, Evanston, IL (US); Andrezj M. Redzisz, Wheeling, IL (US)

Correspondence Address: BANNER & WITCOFF, LTD., TEN SOUTH WACKER DRIVE, SUITE 3000, CHICAGO, IL, 60606, US

(73) Assignee: Travel Caddy, Inc. d/b/a Travelon, Des Plaines, IL (US)

(21) Appl. No.: 11/148,501

(22) Filed: Jun. 9, 2005

Related U.S. Application Data
(63) Continuation-in-part of application No. 10/832,545, filed on Apr. 27, 2004.

(51) Int. Cl. A01K 29/00; A47D 1/02

(52) U.S. Cl. 297/35; 119/28.5

(57) ABSTRACT

A sling construction in the form of a hammock includes a number of panels stitched together in the form of an open top container for placement in the back seat of a motor vehicle to protect the interior of the vehicle and to further protect animals within the sling construction. An alternate embodiment is in the form of a cradle which includes permanent and removable stiffening elements as well as loops and straps for attachment in a vehicle seat.

### CROSS REFERENCE TO RELATED APPLICATION

This is a continuation in part application of application Ser. No. 10/832,545 filed Apr. 27, 2004 entitled “Automobile Pet Bed Construction” which is incorporated herewith by reference and for which priority is claimed.

### BACKGROUND OF THE INVENTION

In a principal aspect the present invention relates to a sling or hammock and seat constructions for maintaining a pet safely on a vehicle seat, particularly the back seat behind a driver and passenger.

When traveling with a pet, particularly a pet that may be large or sheds fur, placement of the pet in the back seat of a vehicle often results in rendering the back seat untidy and unclean. Fur which has been shed and dirt from the animal may result in making the back seat, as well as the front seat, unsuitable or unusable by a subsequent passenger. Additionally, if a pet is placed in a seat a vehicle, the pet may be thrown forward and injured in the event of a sudden stop.

Thus, there has developed the need for means to not only protect the interior upholstery of a vehicle, including the seat and floor area behind the driver and passenger front compartment, but also a means to enhance the safety of a pet placed in the back seat, or any seat, of a vehicle. Merely attaching the pet to a safety belt by means of a leash may not be appropriate or safe. Retaining the pet in a seatbelt will, of course, not be feasible. Thus, the need described has become an important factor, particularly with people who have pets as their companions.

### SUMMARY OF THE INVENTION

Briefly, a first embodiment of the present invention comprises a sling construction which forms a hammock-type structure that is adapted to be suspended or attached into the back seat of a vehicle behind the front seat driver and passenger area. The sling construction includes a bottom panel which fits against the back seat of the vehicle and connected side panels which together form an open top, sack shaped protective enclosure for the pet. The sling construction is fabricated from a material such as a canvas or heavy cloth material and includes various fastening mechanisms which attach the sling construction or hammock-like construction to the backside of the front seat, and in particular the headrests as well as the headrest of the back seat. Side straps with magnetic attachment devices or other means effect attachment of the sides of the sling construction to the vehicle chassis. Openings are provided in the panels for receipt of a vehicle seatbelt through the bottom of the sling construction enabling attachment of a leash for the animal.

The sling construction is generally made from a comfortable, flexible material which provides a safety compartment for the animal retained therein. Various straps attach the sling construction to the seat and to the body of the vehicle. Additionally, by providing openings in the bottom of the sling construction, seatbelts may be fitted through the sling construction to enable use by human passengers without necessitating total removal of the sling construction from the back seat. Various alternative strap and attachment assemblies are also available to enhance the utility of the sling construction.

Additional embodiments of the invention comprise a pet bed which may be positioned on the automobile seat wherein the bed is comprised of a generally rectangular, parallelepiped open topped bag with elements to facilitate maintenance of the shape of the bag or cradle and a further element which facilitates attachment of the bag by means of a seatbelt to the seat upon which the cradle or bag rests. An animal may then fit into the bag or cradle and be protectively retained therein.

Thus, it is an object of the invention to provide improved sling-type construction for placement in the back seat of a vehicle for use by an animal to enhance the safety of the animal and further to provide a means to protect the vehicle seat.

It is a further object of the invention to provide an economical, yet easily usable, rugged sling construction for placement in a motor vehicle and, in particular, in the back seat thereof for protection and transport of an animal.

Yet another object of the invention is to provide a portable or removable sling construction for use in the back seat of a motor vehicle wherein the sling construction may be at least partially detached from its typical service position to thereby enable a passenger to use the sling construction as a seat pad and further wherein the sling construction permits the utilization of seat belts through openings provided in the panels of the sling construction.

Yet another object of the invention is to provide a sling construction for the back seat of a motor vehicle which protects the interior upholstery of the vehicle.

Another object of the invention is to provide a pet bed construction for use in an automobile which is foldable between a compact storage position and an expanded use position.

A further object of the invention is to provide a pet bed construction which provides a cradle, container, or bag into which a pet may be comfortably positioned in an automobile or vehicle.

Another object of the invention is to provide a pet bed for use in an automobile on a seat thereof.

Yet a further object of the invention is to provide a pet bed or cradle which may be disassembled easily for storage or assembled easily for installation on a vehicle seat.

Another object of the invention is to provide a pet bed construction which is easy to use, economical, easy to clean, and easy to install and remove from a vehicle.

These and other objects, advantages and features of the invention will be set forth in the detailed description which follows.

### BRIEF DESCRIPTION OF THE DRAWING

In the detailed description which follows reference will be made to the drawing comprised of the following Figures:

FIG. 1 is an isometric view of the sling construction of the invention positioned within the back seat of a motor vehicle;

FIG. 2 is an isometric view of the sling construction of FIG. 1 as installed in a motor vehicle;

FIG. 3 is an isometric view similar to FIG. 2 wherein a center panel associated with the vertical or generally vertical back portion of the sling construction is opened for placement of an arm rest;

FIG. 4 is an enlarged isometric view of the zipper construction associated with a seam in the back panel of the sling construction;

FIG. 5 is an isometric view of the sling construction of FIG. 1 wherein the sling construction has been detached from the vehicle front seat and folded in a manner to enable the seat construction to comprise a cover for the vehicle back seat wherein a passenger may sit on the cover and still utilize the seatbelts in the back seat of the vehicle;

FIG. 6 is an isometric view of the sling construction of FIG. 5 in a folded condition to enable a passenger to sit on the sling;

FIG. 7 is a side elevation of the sling construction positioned for receipt of a pet;

FIG. 8 is a side elevation of the sling construction positioned for entry into the sling;

FIG. 9 is a side elevation of the sling construction wherein an infant seat has been positioned in the sling construction;

FIG. 10 is a side elevation illustrating the manner in which an individual would sit in the back seat of a vehicle utilizing the sling construction which has been opened in the manner depicted in FIG. 6;

FIG. 11 is an isometric view of an alternative sling construction wherein straps are provided for attaching the vertical back panel thereof to hooks in that circumstance where there are no back seat headrests;

FIG. 12 is an enlarged isometric view of a construction of the type depicted in FIG. 11 for attaching the sling construction to hooks behind the back seat;

FIG. 13 is an isometric view of an alternative embodiment of the invention as viewed from the front side thereof;

FIG. 14 is an isometric view of the pet bed of FIG. 13 as viewed from the back side thereof;

FIG. 15 is a front elevation of the pet bed of FIG. 13;

FIG. 16 is a side elevation of the pet bed of FIG. 13 in a partial perspective or isometric view;

FIG. 17 is an opposite side view of the pet bed construction of FIG. 16;

FIG. 18 is a bottom plan view of the pet bed of FIG. 13;

FIG. 19 is an isometric view of the pet bed of FIG. 13 illustrating the manner in which stiffening elements are incorporated with respect to the side panels thereof;

FIG. 20 is an isometric view similar to FIG. 19 illustrating the manner of attachment of a seatbelt to the pet bed construction depicted;

FIG. 21 is an isometric front view of the pet bed of FIG. 13 as installed in a vehicle on a vehicle seat; and

FIG. 22 is an isometric view depicting the manner of use of the pet bed wherein a pet is positioned within the pet bed.

### DESCRIPTION OF THE PREFERRD EMBODIMENTS

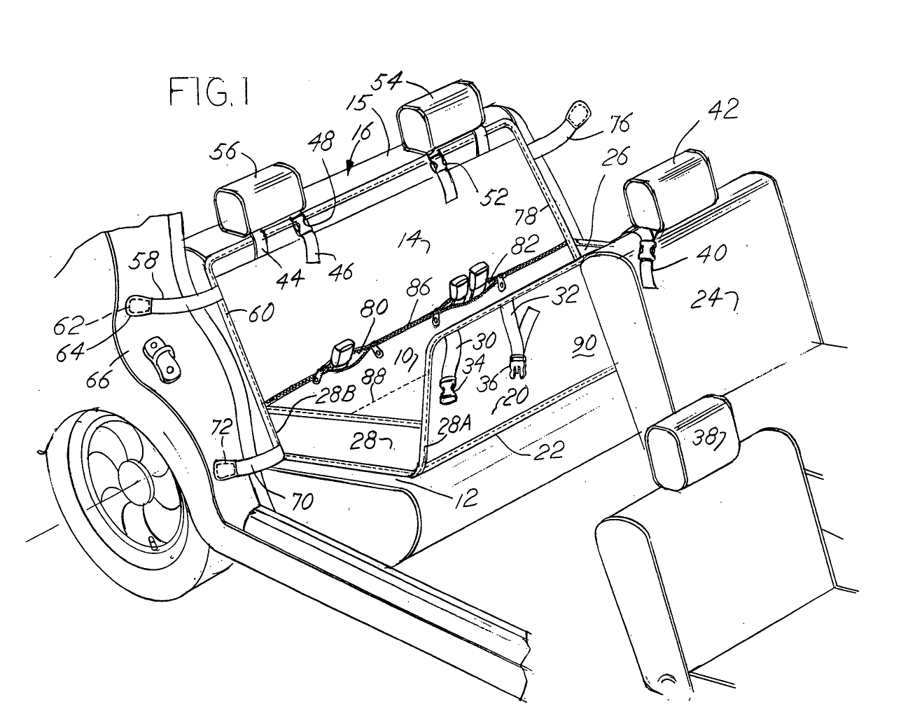

Referring to FIGS. 1-12, the sling construction or “hammock” version of the invention includes a lower or bottom panel 10 which is sized and designed to fit on the generally horizontal seat portion of the back seat of a vehicle. The bottom panel 10 is typically a rectangular shape and dimensioned so that it covers the seat portion 12. The bottom panel 10 is connected to a generally upright or vertical back panel 14, which has a generally rectangular shape in a preferred embodiment, and which is sized to fit against the generally vertical back support section 16 of the back seat of a motor vehicle.

In a similar fashion, a front panel 20 is attached to the bottom panel 10. The front panel 20 is generally rectangular in shape and is attached by binding and stitching to the front edge 22 of the bottom panel 10. The front panel 20 is sized so that it will extend upwardly from the bottom panel 10 an appropriate height not exceeding the height of the front seat back rest, for example, front seat back rest 24.

The sling construction further includes a first lateral side web or panel 26 connecting the front panel 14, bottom panel 10 and front panel 20. In similar fashion, the opposite side of the sling construction or hammock includes a lateral side web or panel 28 which, in like manner, is stitched and attached to the back panel 14, bottom panel 10 and front panel 20. Thus, a five-sided, open top compartment is provided forming a hammock or enclosure in which an animal may be retained. The configuration of the sling is generally that of a skewed parallelepiped. However, the arrangement of panels and shape of the panels may be varied without departing from the spirit and scope of the invention. Also, the side panels 26 and 28 may be detachably connected along one or more sides thereof. For example, in FIG. 1, sides 28A and 28B may be zipper seams.

The front panel 20 further includes straps such as straps 30 and 32 which may be connected together by means of buckle elements 34 and 36 and fitted around the headrest 38 of the passenger side of the front seat. Similarly, a strap and fastening mechanism 40 fits around a headrest 42 associated with the driver's side of the front seat of the motor vehicle.

In similar fashion, the back panel 14 includes straps such as straps 44 and 46 connected by a fastening or buckle mechanism 48 for fitting about headrest 50 associated with the backrest 15 of the back seat 16. An additional fastening mechanism 52 attaches the opposite side of the back panel 14 to or around back seat headrest 54.

Lateral side straps such as lateral side strap 58 are attached to the side edge 60 of back panel 14. The strap 58 includes a magnet 62 retained within a pocket 64 attached to the end of strap 58. The magnet 62 enables and secures attachment of the strap 58 to the steel chassis 66 of the motor vehicle. In similar fashion, a strap 70 attached to the lower side edge 60 of back panel 14 includes a magnet 72 which enables attachment of the strap 70 to the chassis of the vehicle. In this manner, the side of the back panel 14 is retained so as to insure maintenance of the sling construction or hammock in an open condition. Similar side straps such as side strap 76 are provided on the opposite edge or side 78 of the back panel 14.

The back panel 14 includes zipper openings such as openings 80 and 82 in a seam 86 slightly above the seam 88 connecting the back panel 14 to the bottom panel 10. The seam 86 may, in fact, be positioned within the seam 88 or above the seam 88 as depicted in FIG. 1.

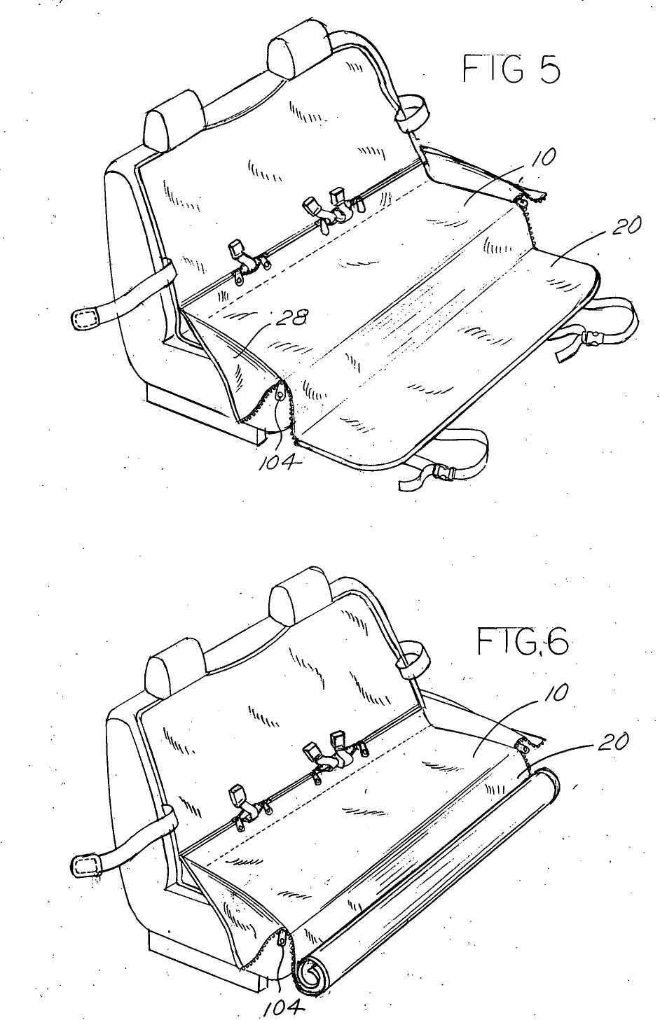

It is to be noted that the lateral side panels 26 and 28 are of a reduced height relative to the front side panel 20 and back side panel 14. This enables ease of access to the sling construction. Further, all of the panels are constructed or configured of a flexible or fabric material. This enables the front panel 20 and lateral side panel 26 and 28, for example, to be folded down as depicted in FIGS. 5 and 6 to enable use of the sling construction as a seat cover for a passenger who would sit on the outside face 90 of the front panel. The sling construction otherwise, as depicted in FIG. 1, provides a means to protect the upholstery within the vehicle and protects an animal retained within the sling construction. Further, the animal may be attached to a seatbelt via a leash. This enables safe retention of the animal within the sling construction while permitting the animal to move appropriately.

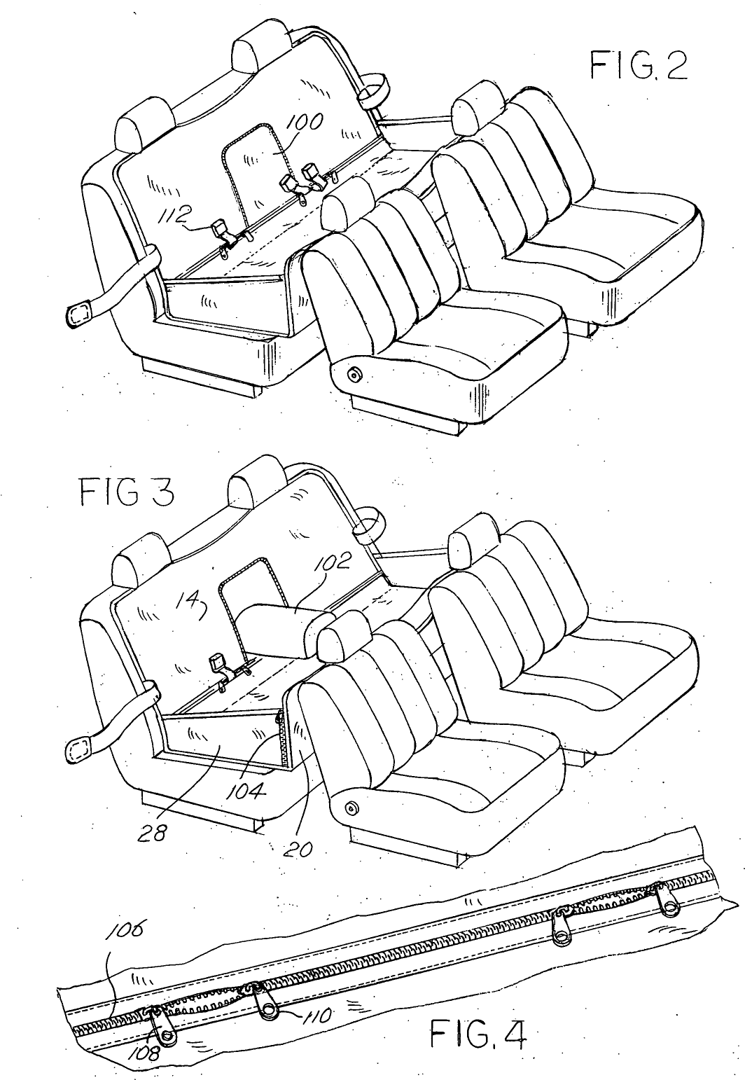

Referring to FIGS. 2 and 3, the back panel 14 may include center access panel 100 attached, for example, by means of a zipper. The center access panel 100 may be opened as depicted in FIG. 3 so that a center arm rest 102 may be lowered. Note also when referring to FIG. 3 that a zipper 104 may be utilized to attach the front edge of a side panel 28 to a front panel 20.

FIG. 4 illustrates in greater detail the construction of a zipper seam 106 having first and second zippers 108 and 110 which enable opening and closing of the zipper seam 106 so that seat belts, for example, seat belts 112 in FIG. 2, to be made available for use.

FIGS. 5 and 6 illustrate in greater detail the manner in which the bottom panel 10 may be folded, more particularly the front panel 20 may be detached from side panels 28 and 26 by operation of the zipper 104. This enables the front panel 20 to be folded down on the floor of a vehicle and as depicted in FIG. 6, rolled up to fit under or adjacent the edge of the seat of the vehicle.

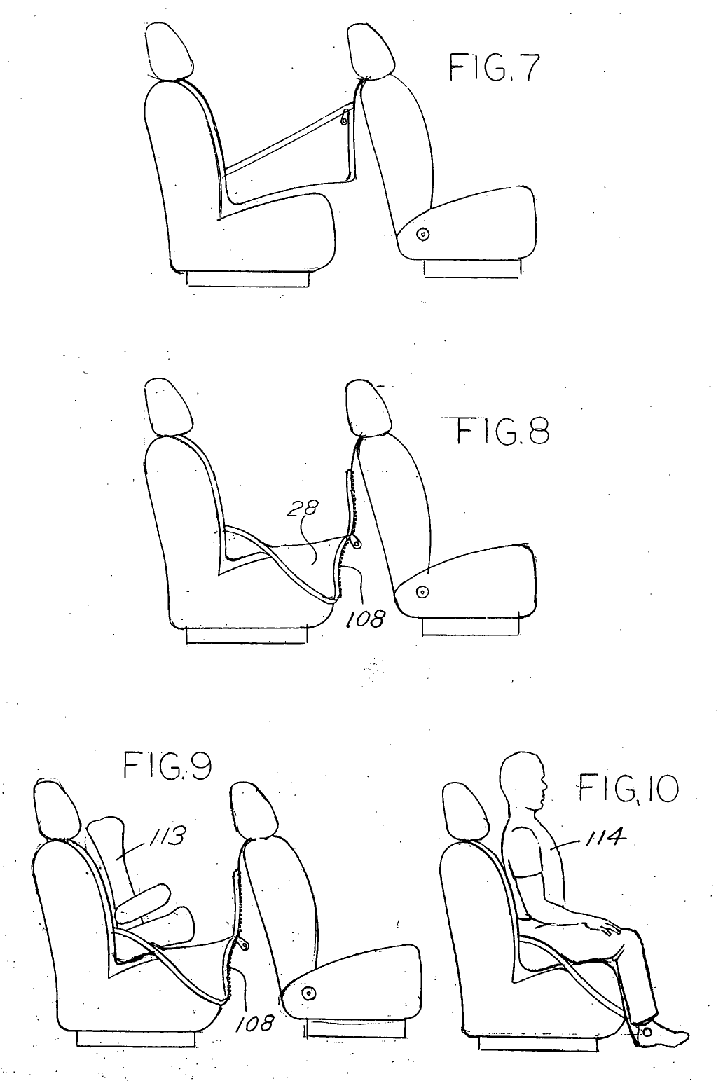

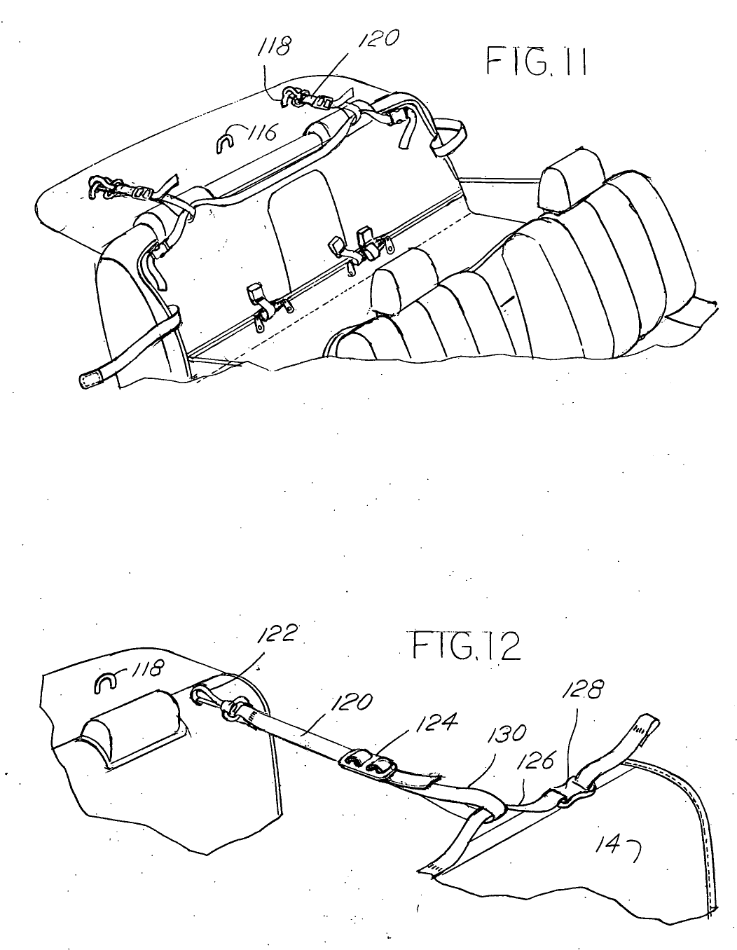

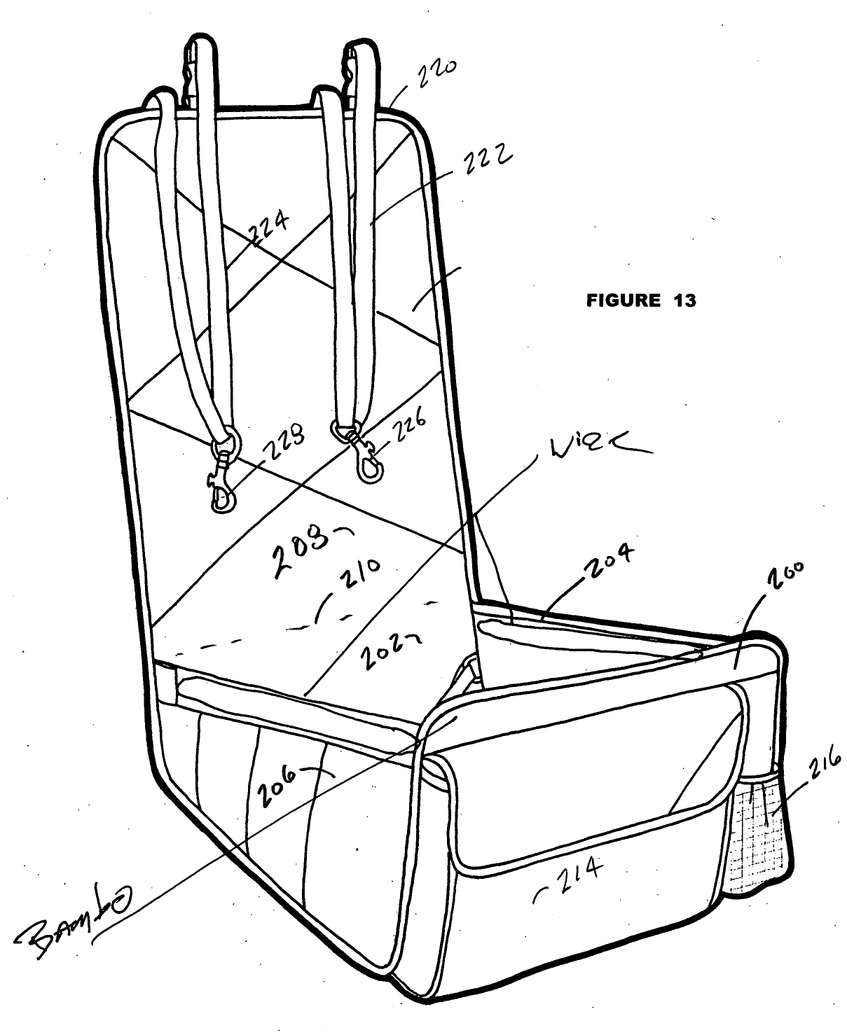

FIGS. 8-10 illustrate the various alternative modes of operation of the sling construction. As shown in FIG. 7, the sling construction is held in place between the front and back seat by virtue of straps which suspend it between the headrests. FIG. 8 depicts the manner in which side panel 28 may be released or opened when the pet is initially placed in the back seat, for example. FIG. 9 illustrates the manner in which the back seat may be used to accommodate a child's seat, for example, the child seat 113 which will be retained by seat belt straps on the sling construction. The combination of utilizing the sling construction along with a child's seat would potentially enhance the safety of a child in the seat should the child accidentally slip from the seat during travel.

FIG. 10 illustrates the manner in which an individual 114 would sit in the back seat in the event the sling construction is detached as depicted, for example, in FIGS. 5 and 6.

Next referring to FIGS. 11 and 12 there are circumstances where the sling construction may not be attachable to a headrest of a back seat inasmuch as such headrests are not available. In such circumstance, the headrest of such a vehicle will generally include loops or hooks such as loops or hooks 116 and 118 to which a strap 120 could be attached. As depicted in FIG. 12, the strap 120 includes a buckle 122 which cooperates with and is attachable to a hook 118. The strap 120 is adjustable by means of the adjustable length mechanism 124. The strap 120 is attachable to a secondary strap member 126 attached to the edge of the vertical or nearly vertical panel 14 of the sling construction as depicted in FIG. 11. The strap 120 is also adjustable in length and may also be detached inasmuch as the buckle 128 may be disconnected so that the strap 126 will fit through a loop 130 defined in the strap 120.

Various types of strap, buckle and loop mechanisms may be utilized in combination with the various panels forming the sling construction. The sling construction may be attached to the front and back seats themselves or to the headrests associated with the seats or the hooks which are somehow incorporated in the various seats. The side panels 26 and 28 are at least partially detachable and foldable so as to enable improved access to the sling construction and so as to enable, for example, a passenger to sit on the sling construction when it is in the condition such as exemplified by FIGS. 5 and 6. In the preferred embodiment, the various panels forming the bottom front side and back side of the sling are generally quadrilateral and designed to be foldable for storage when not in use.

Referring to FIG. 6, it is possible to provide a means for rolling or folding the front side panel and for retaining that front side panel in the rolled condition. For example, a hook and loop strap construction can be utilized to hold the rolled or folded panel in a manner which will facilitate placement against the back seat and underneath the feet of an individual sitting in the back seat.

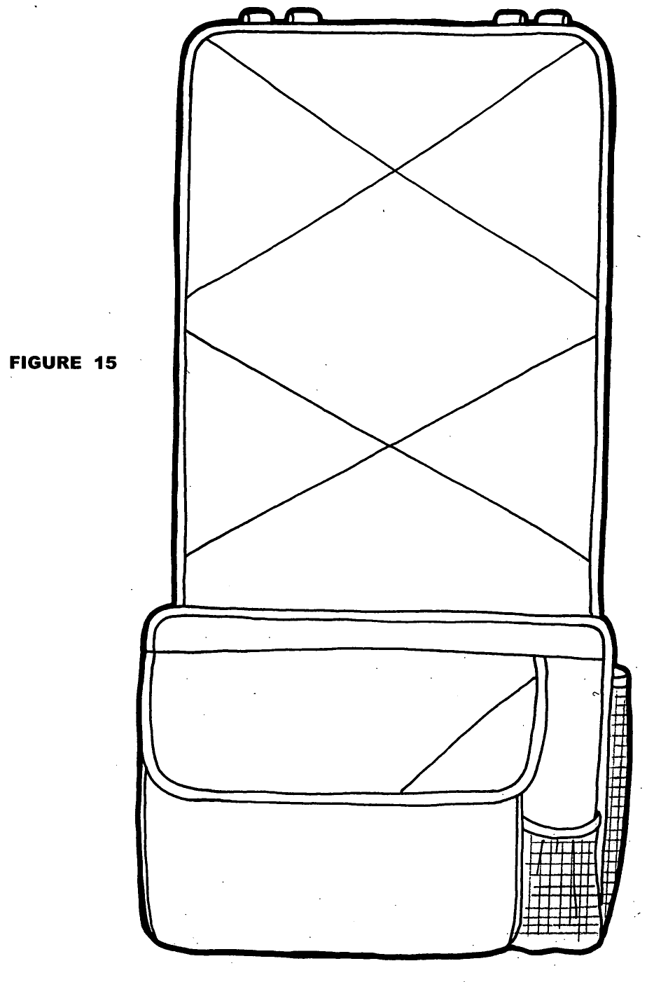

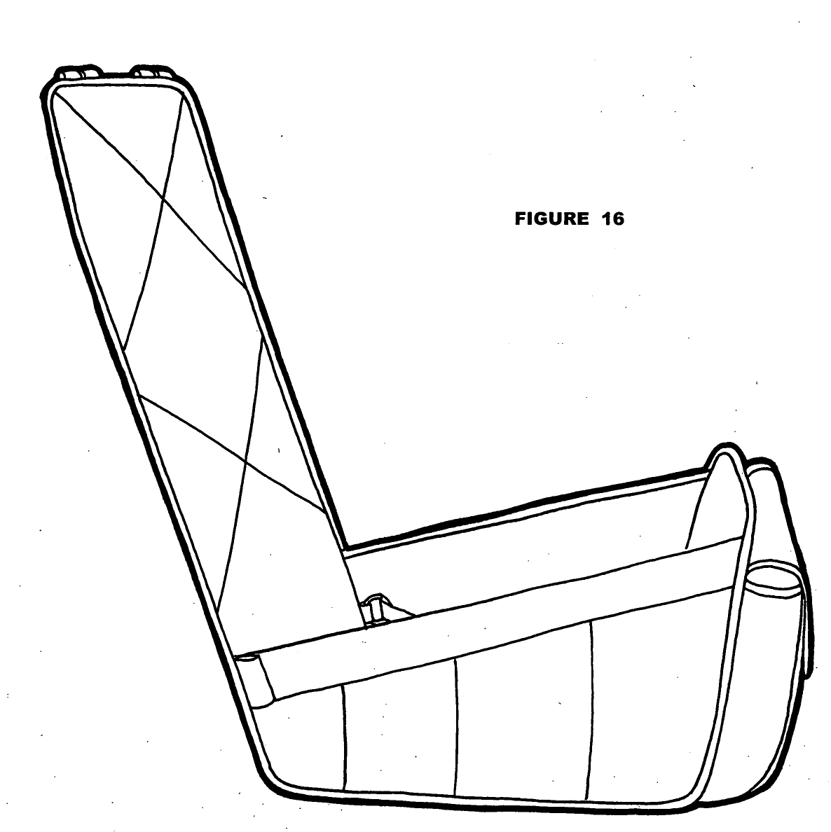

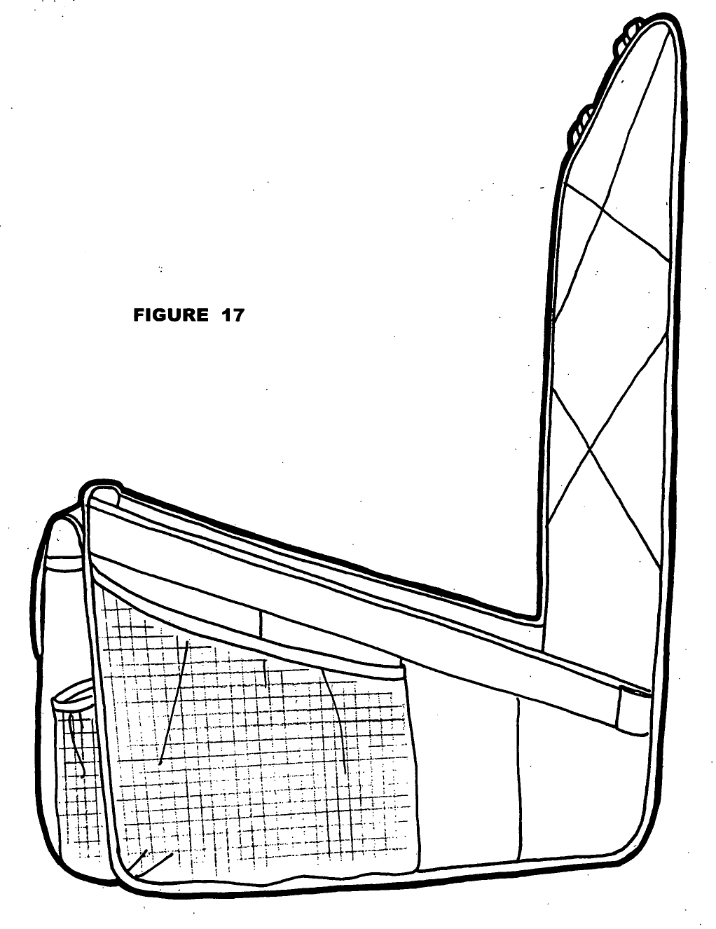

FIGS. 13-22 illustrate a variation of the invention comprising an alternative embodiment for cradling or supporting a pet in a motor vehicle. The version of FIGS. 13-22 may be easily incorporated in any seat of a motor vehicle and is designed to be cooperative with a motor vehicle seatbelt as well as a headrest incorporated with the vehicle seat. The embodiment of FIGS. 13-22 is also foldable for purposes of storage and for packaging. It may be easily unfolded and opened for use and installation in a vehicle.

Thus, referring to FIGS. 13-22, the bed includes a front panel 200 which is generally rectangular in configuration and spaced from a back panel 202 which is joined to the front panel 200 by a first lateral side panel 204 and a second, spaced lateral side panel 206. Generally, the configuration of the front panel 200 and the back panel 202 is rectangular. A dotted line in FIG. 13, for example, illustrates the demarcation of the back panel 282 from an upper flap extension 208. In other words, the back panel 202 includes an upper or top edge 210 and extension 208.

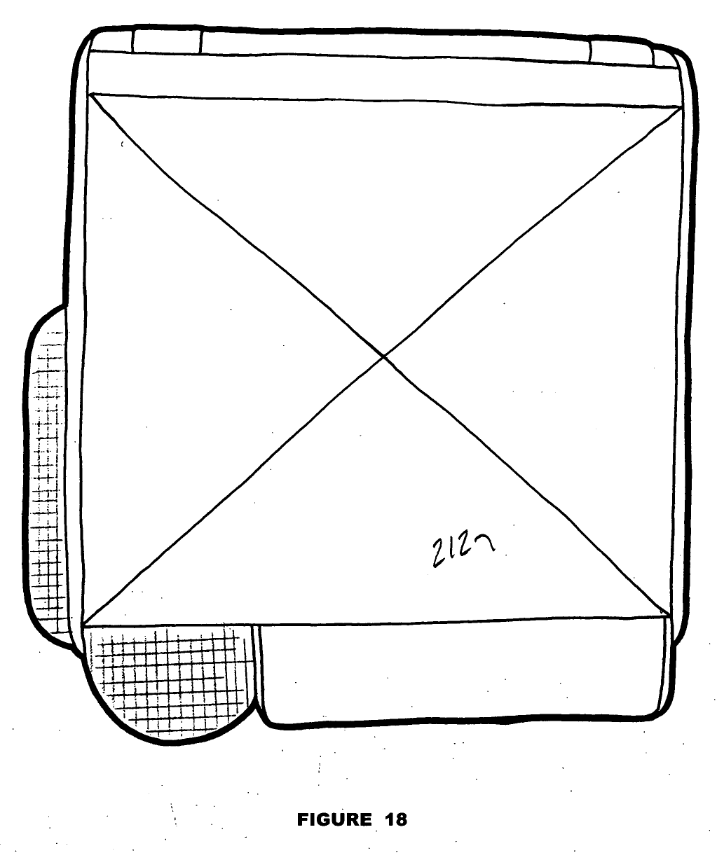

The back panel 202 is joined or connected to the front panel 200 by the first side panel 204 and second side panel 206, each of which is generally trapezoidal in shape and each is comprised of a flexible fabric material. The lateral side panels 204 and 206 may be padded, for example, to facilitate and provide a comfortable interior, cradle or bag construction. The four panels 200, 202, 204 and 206 are arranged and attached to a lower, bottom or base panel 212 as depicted in FIG. 18. The base panel 212 is generally rectangular in configuration and may also be padded. In a preferred embodiment, the base panel 212 is preferably a flexible fabric material so that it may be folded if desired.

The panels, for example, the front side panel 200 may include a pocket or pockets affixed thereto. Thus, front panel 200 includes a storage pocket 214 and a mesh pocket 216. The side or lateral panel 204 further includes a mesh pocket 218.

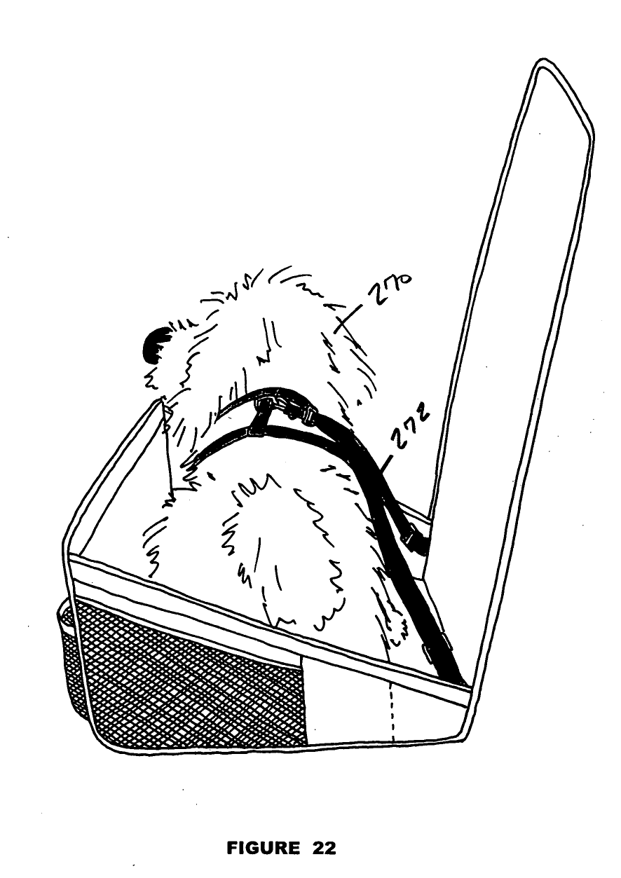

Extending from the top edge 210 of the back side panel 202 is the flexible cover panel 208. The flexible cover panel 208 is sized so that it may fit against the back side of a seat of a vehicle, for example, as depicted in FIG. 21. Again, the back side panel 202 and cover panel 208 are generally made from a flexible fabric material and may be padded for purposes of comfort. Attached to a top edge 220 of the back side panel 208 are retention straps 222 and 224. The retention straps 222 and 224 include buckles, such as buckles 226 and 228, which may be connected together. The length of each of the straps 222 and 224 is preferably adjustable so that the straps 222 and 224 may be fitted around a headrest, for example, as depicted in FIG. 21. Alternatively, the straps 222 and 224 may be connected to a back side of a seat in a manner which retains the flexible cover panel 208 in the position illustrated, for example, in FIG. 21.

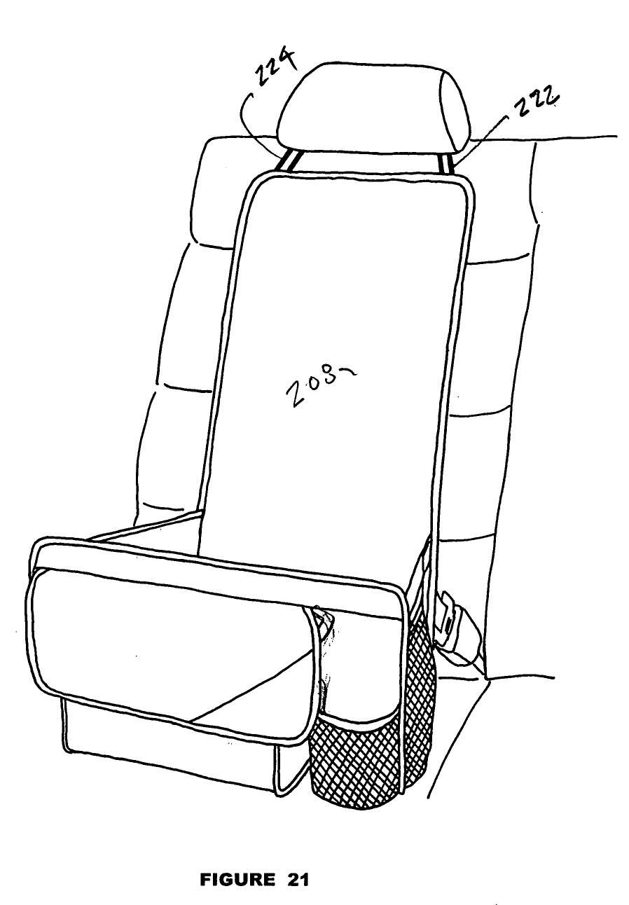

The back panel 202 includes a rear or back side surface 230 with a first retention loop 232 and a second retention loop 234. The loops 232 and 234 extend vertically from a seat as depicted, for example, in FIG. 20. Thus, a flexible seatbelt 236 may be fitted through the loops 232 and 234 for retaining the cradle or bag assembly as depicted in FIG. 21.

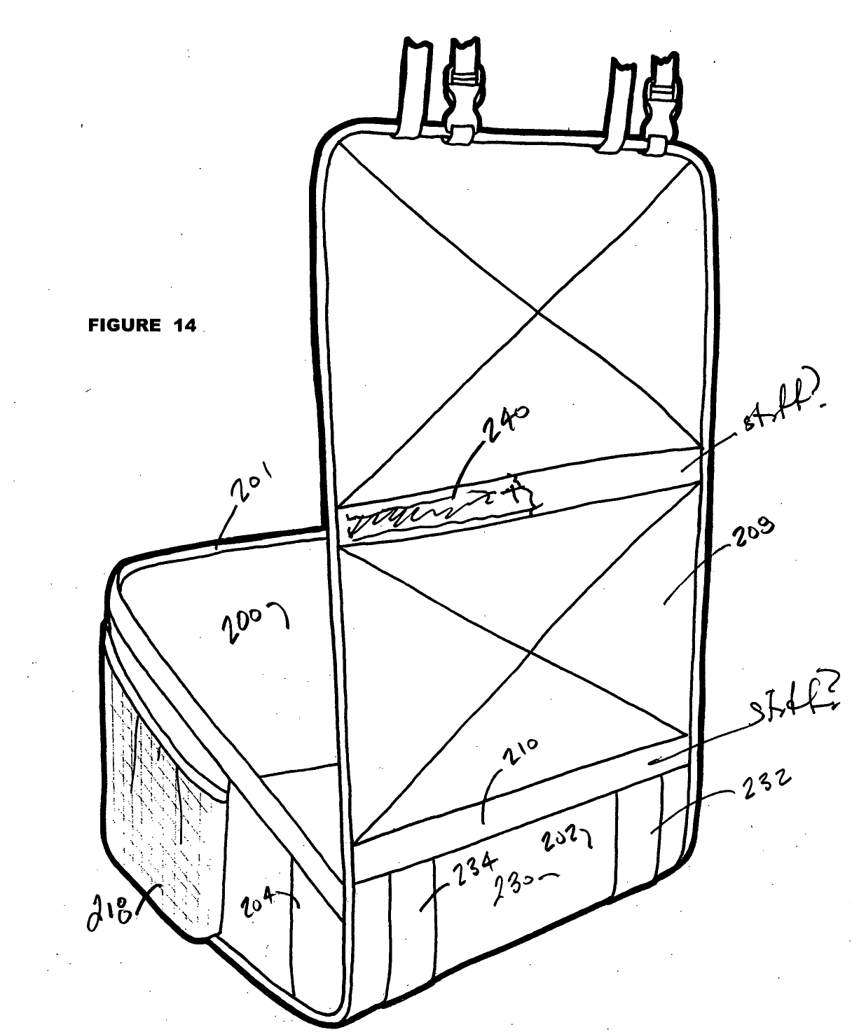

As an optional feature of the embodiment being described, the flexible cover panel 208 may include stiffening elements such as a bamboo or plastic elements or strips 240 sewn into the fabric comprising the flexible cover panel 208. A stiffening element may, for example, be incorporated in the top edge 210 of the back panel 202 and may also be incorporated, for example, along a line in the flexible cover panel 208 as depicted, for example, in FIG. 14. The stiffening element, such as the stiffening element 240, is permanently incorporated into the embodiment or assembly depicted in the preferred embodiment. Additionally, the front panel 200 may include a stiffening element (not shown) incorporated within the fabric comprising the front panel 200 along the top edge 201. A vertical stiffening element may also be included in the front panel 200 or the front panel may be formed around a board, such as a polyethylene board, to provide stiffening and shape enhancement. Similarly, the back side panel 202 may include such a stiffening construction or element.

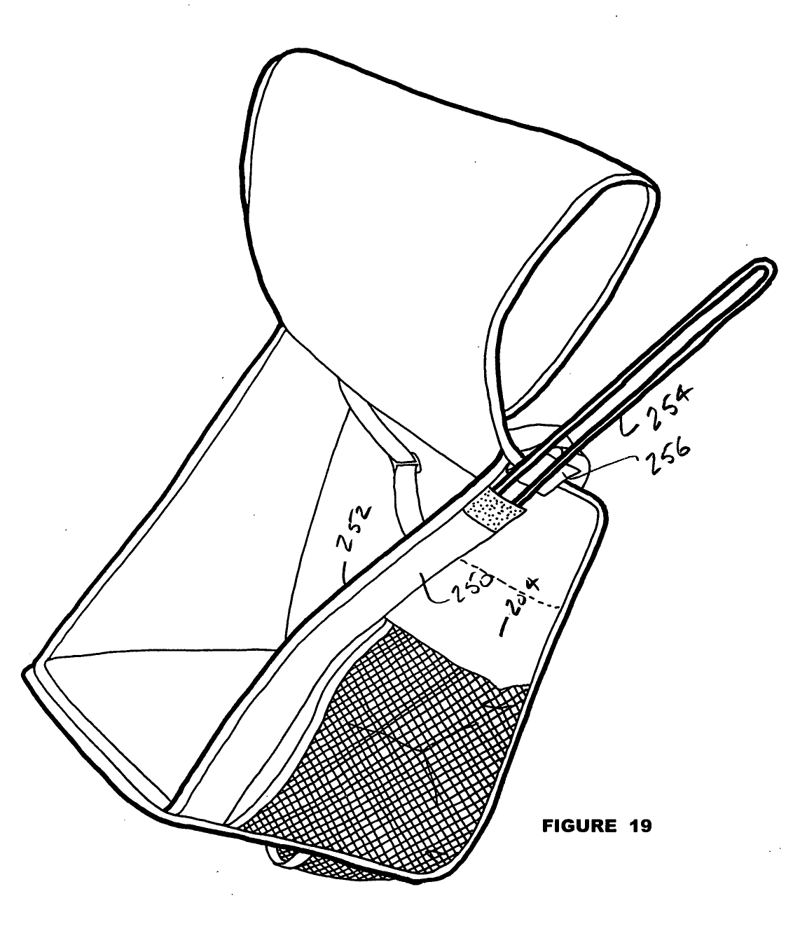

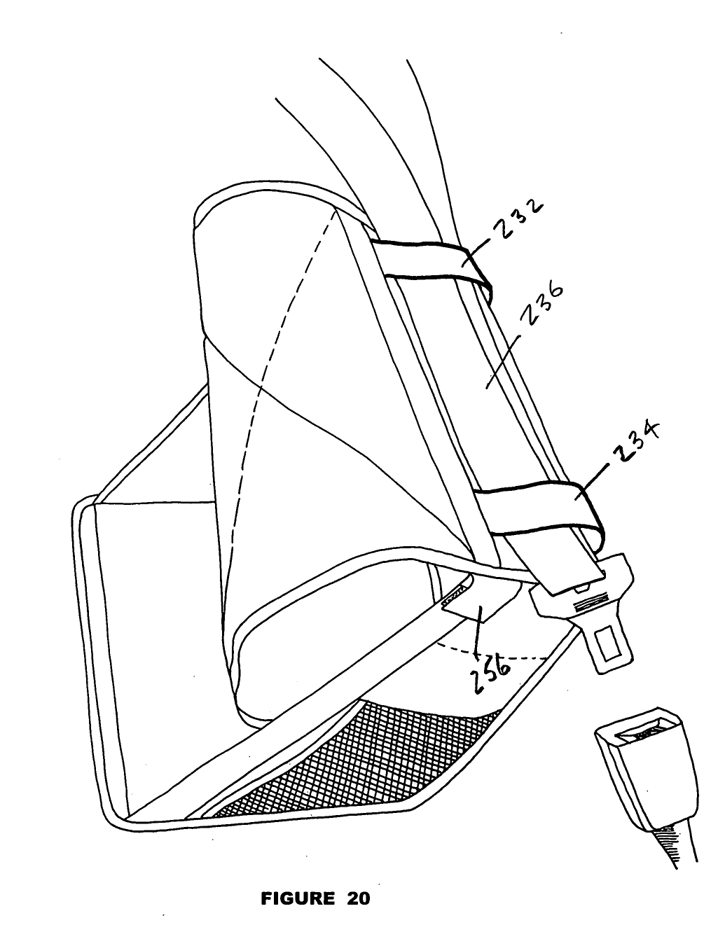

However, the lateral side panels 204 and 206 do not include a permanent stiffening construction. Rather, those side panels 204, 206 preferably each include a mechanism which provides for stiffening along the upper edge of the side panels 204, 206 and the stiffening mechanism is removable or detachable to enable folding of the pet bed or cradle as depicted in the figures. Thus, referring to FIG. 19, a pocket or slot 250 is formed along a top edge 252 of the lateral side 204. The pocket 250 receives a metal rod 254 which may slide into the pocket and be retained by a flap 256. Such a pocket assembly may be provided for each of the lateral sides 204 and 206 to provide a means to stiffen and maintain the configuration of the cradle or pet bed depicted in the drawing when in use, such as depicted in FIG. 22. There, an animal 270 is depicted within the cradle or bed as described. A leash 272 fastened to the inside of the cradle or bed maintains the animal within the protected environment of the cradle or bed.

Thus, there has been described a cradle or bed formed on a generally rectangular base panel which is comprised of a foldable material wherein a front side panel extends upwardly from the front side edge of the base panel and a back side panel extends upwardly from the back side of the base panel. Flexible lateral side panels which may be reinforced by stiffening elements are also provided. When those side panel reinforcing elements or stiffening elements are removed, the front side panel, the back side panel and the flexible cover panel may all be folded into a compact, flattened condition for storage or packaging or the like. Variations of this particular embodiment may be adopted. For example, additional loops or other fastening means may be provided to attach a seatbelt to the carrier. The flexible cover panel may be configured in a manner which omits the flexible cover panel. The stiffening elements and formed maintenance elements described may come in various forms, configurations and shapes.

Variations and modifications may be made to the construction as described. The shaping of the panels may be varied. The arrangement and attachment of straps and fastening mechanisms may be varied. Thus, the invention is to be limited only by the following claims and equivalents thereof.

1. A pet bed for use as an automobile seat comprising, in combination:
a first generally rectangular base panel comprised of a generally foldable material, said base panel including a front side edge, a back side edge and first and second connecting spaced lateral side edges;
a front side panel connected to and extendable upwardly from the front side edge of the base panel, said front side panel including a form maintenance element, said front side panel being generally rectangular in shape;
a first generally flexible material lateral side panel connected to and extendable upwardly from the first lateral side edge of the base panel;
a second generally flexible material lateral side panel connected to and extendable upwardly from the second lateral side edge of the base panel;
a back side panel connectable to and extendable upwardly from the back side edge of the base panel, said back side panel including an inside face and an outside face;
said first lateral side panel and said second lateral side panel each being connected between the front side panel and back side panel to form an open top enclosure having four sides and a base for placement of a pet therein,
said first side panel and second side panel each including a removable stiffening element extending substantially between the front side panel and back side panel to thereby generally maintain the configuration of the side panels, said back side panel outside face including a connecting element for engaging a seat belt to hold the bed in position of a seat; said back side panel further including a form maintenance element to generally maintain the back side panel with a rectangular shape having a top edge.

2. The bed of claim 1 including a flexible cover panel extending from the top edge of the back panel.

3. The bed of claim 1 wherein the back side panel connecting element comprises at least one loop for receipt of a seatbelt.

4. The bed of claim 1 further including a leash on the inside of the enclosure.

5. The bed of claim 1 further including a storage pocket attached to at least one of the side panels.

6. The bed of claim 1 wherein the removable stiffening element comprises a rod member and said lateral side panels each include a pocket for receipt of a rod member.

7. The bed of claim 6 further including a flexible cover panel extending from the top edge of the back panel.

8. The bed of claim 6 wherein the back side panel connecting element comprises at least one loop for receipt of a seat belt.

9. The bed of claim 6 further including a flexible cover panel extending from the top edge of the back panel and the connecting element comprises at least one loop for receipt of a seat belt.

10. The bed of claim 6 further including a leash on the inside of the enclosure.
